(19) United States
(12) Patent Application Publication
(10) Pub. No.: US 2011/0266873 A1
(43) Pub. Date: Nov. 3, 2011

(54) INFORMATION PROCESSING APPARATUS AND METHOD OF CONTROLLING AN INFORMATION PROCESSING APPARATUS

(75) Inventor: Kazuhiko Tsuji, Hamura-shi (JP)

(73) Assignee: KABUSHIKI KAISHA TOSHIBA, Tokyo (JP)

(21) Appl. No.: 13/096,829

(22) Filed: Apr. 28, 2011

(30) Foreign Application Priority Data
Apr. 28, 2010 (JP) 2010-104340

(51) Int. Cl. H02J 7/00

(52) U.S. Cl. 307/66

(57) ABSTRACT

According to one embodiment, an information processing apparatus includes a setting module. The setting module configured to set the apparatus to a first mode when first external direct current power is supplied to the apparatus, and to set the apparatus to a second mode when the first external direct current power and second external direct current power are supplied to the apparatus, wherein an operation of the apparatus at a power greater than the first external direct current power is disabled in the first mode, and an operation of the apparatus at a power greater than the first external direct current power is enabled in the second mode.

### CROSS-REFERENCE TO RELATED APPLICATIONS

This application is based upon and claims the benefit of priority from Japanese Patent Application No. 2010-104340, filed Apr. 28, 2010; the entire contents of which are incorporated herein by reference.

### FIELD

Embodiments described herein relate generally to an information processing apparatus configured to receive power form a plurality of power supplies, and to a method of controlling an information processing apparatus of this type.

### BACKGROUND

In recent years, electronic apparatuses have which can be quickly recharged been developed. Quick recharging is achieved by supplying power to the apparatus at a higher current than in normal recharging. The current for quick recharging is, for example, three times the current for normal recharging.

To supply power to the apparatus at a current three times that for normal recharging, an AC adapter of a high rated current must be used. The greater the rated current, the larger the AC adapter will be. The user of the apparatus may bring the AC adapter, along with the apparatus, to a location where he or she uses the apparatus. In view of this, the AC adapter should be as small as possible.

Moreover, some types of processors such as CPUs have the function of increasing the operating clock frequency. If the operating clock frequency is increased, however, the power consumption of the processor will increase. As a result, the apparatus incorporating the processor must be recharged with an AC adapter of a high rated current.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of a notebook personal computer, i.e., an information processing apparatus according to an embodiment, also showing an AC adapter and a docking station;

FIG. 2 is a perspective view showing the back of the computer shown in FIG. 1;

FIG. 3 is a block diagram showing system composed of the computer, AC adapter and docking station, all shown in FIG. 2;

FIG. 4 is a block diagram showing a system designed to enable or disable a quick recharging mode or a boost function;

FIG. 5 is a flowchart explaining the control sequence the controller shown in FIG. 4 performs when power is supplied from the docking station or the AC adapter;

FIG. 6 is a flowchart explaining the sequence of controlling the current supplied to the battery; and

FIG. 7 is a flowchart explaining how the boost function is controlled for the CPU and the GPU.

### DETAILED DESCRIPTION

Various embodiments will be described hereinafter with reference to the accompanying drawings.

In general, according to one embodiment, an information processing apparatus includes a setting module. The setting module configured to set the apparatus to a first mode when first external direct current power is supplied to the apparatus, and to set the apparatus to a second mode when the first external direct current power and second external direct current power are supplied to the apparatus, wherein an operation of the apparatus at a power greater than the first external direct current power is disabled in the first mode, and an operation of the apparatus at a power greater than the first external direct current power is enabled in the second mode.

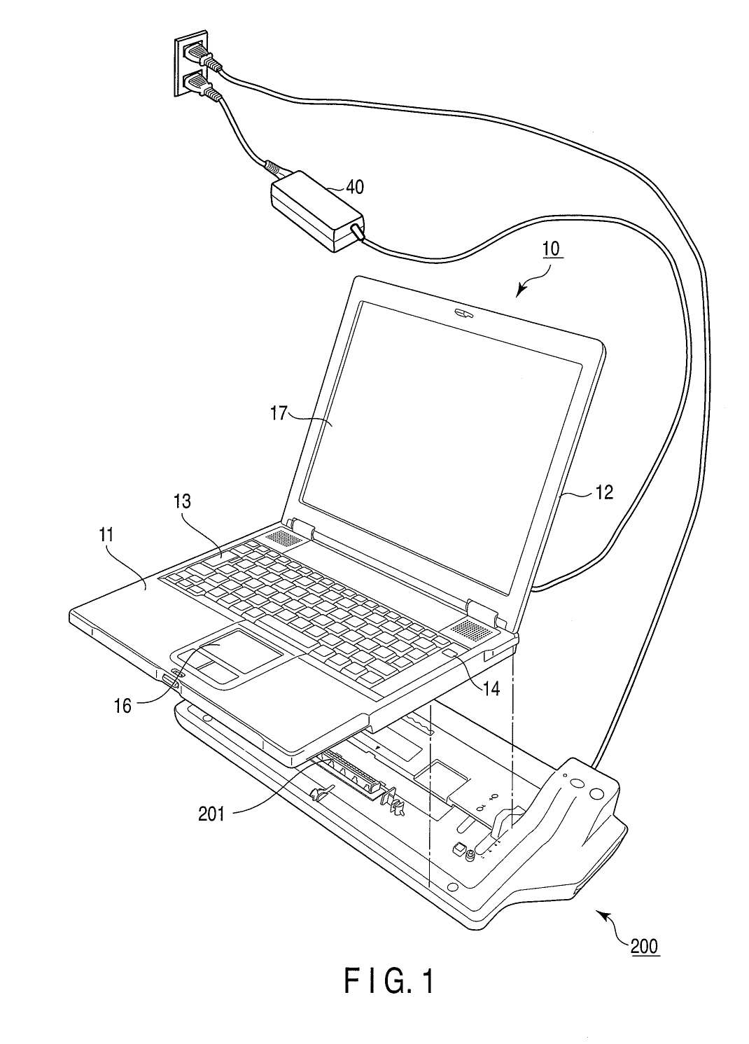

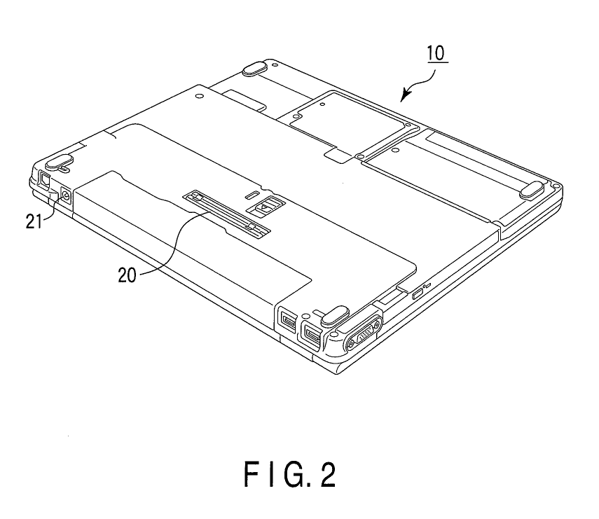

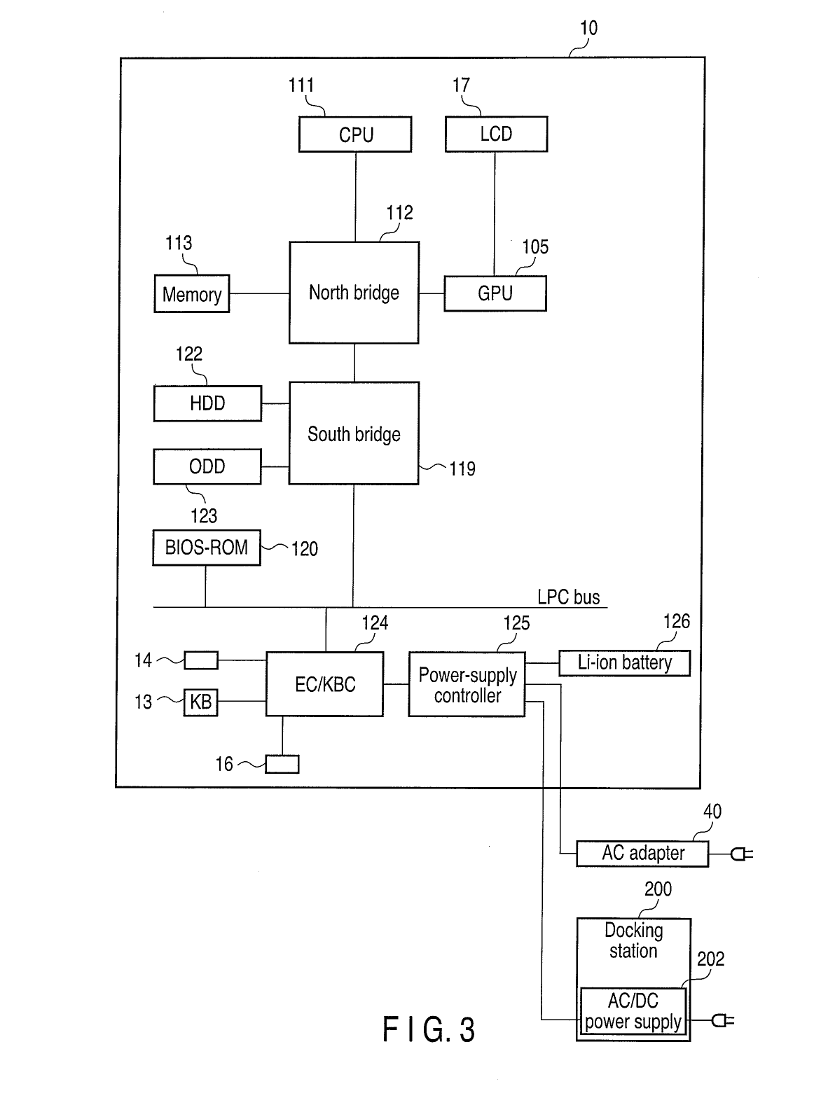

An information processing apparatus according to an embodiment will be described with reference to FIG. 1, FIG. 2 and FIG. 3. Assume that the information processing apparatus is implemented as a notebook personal computer 10, which is a battery-driven portable computer.

FIG. 1 is a perspective view of the notebook personal computer, with its display unit opened, showing a docking station used as extension unit for the computer. FIG. 2 is a perspective view showing the computer as seen from the back.

The computer 10 is composed of a computer main body 11 and a display unit 12. The display unit 12 incorporates a display device, which is a liquid crystal display (LCD) 17. The screen of the LCD 17 is located, almost at center of the display unit 12.

The display unit 12 is secured to the computer main body 11 and can rotate between an opened position and a closed position, with respect to the computer main body 11. The computer main body 11 is shaped like a thin box. On its top, a keyboard 13, a power switch 14 and a touch pad 16, etc. are arranged. The power switch 14 may be operated to turn on or off the computer 10.

The computer 10 can be mounted on a docking station 200, which is an external device. Once the computer 10 has been mounted on the docking station 200, the docking connector 210 of the docking station 200 fits into the docking port 20 provided in the back of the computer main body 11. Then, drive power and signals can be transferred. The computer main body 11 has a power port 21 in the back. The plug of an AC adapter 40 can be inserted into the power port 21.

The system composed of the computer 10, AC adapter 40 and docking station 200 will be described with reference to FIG. 3.

As shown in FIG. 3, the computer 10 comprises a CPU 111, a north bridge 112, a main memory 113, a graphics processing unit (GPU) 114, a south bridge 119, a BIOS-ROM 121, a hard disk drive (HDD) 122, and an embedded controller/keyboard controller IC (EC/KBC) 124.

The CPU 111 is a processor provided to control the other components of the computer 10. The CPU 111 executes the operating system (OS) and various application programs loaded into the main memory 113 from the hard disk drive 122.

The CPU 111 also executes the basic input/output system (BIOS) program stored in the BIOS-ROM 121. The BIOS is a program described to control hardware.

The north bridge 112 is a bridge device that connects the local bus of the CPU 111 to the south bridge 119. The north bridge 112 incorporates a memory controller. The memory controller controls the access to the main memory 113. The north bridge 112 has the function of performing communication with the GPU 105 through a peripheral component interconnect (PCI) Express bus or the like. The CPU 111 has boost function of monitoring the power consumption and temperature and automatically increasing the clock frequency within the thermal design power, if possible in respect of the power consumption and temperature monitored.

The GPU 105 is a display controller configured to control the LCD 17 that is used as display monitor of the computer 10. The GPU 105 has a video memory (VRAM), and generates a video signal from the display data written in the video memory in accordance with the OS/application programs. The video signal thus generated represents an image, which will be displayed by the LCD 17 of the display unit 12. The GPU 105 also has a boost function of monitoring the power consumption and temperature, and automatically increasing the clock frequency, if possible in respect of the power consumption and temperature monitored.

The south bridge 119 controls the devices on the low-pin count (LPC) bus. The south bridge 119 incorporates a serial AT attachment (SATA) controller and a peripheral component interconnect (PCI) Express controller and a UBS controller, which control the hard disk drive 122 and an optical disk driver (ODD) 123.

The optical disk driver 123 is a drive unit configured to drive storage media such as a DVD and a CD. The optical disk driver 123 is a drive unit that can write data to a writable optical medium such as CD-R or DVD-R, and can write and erase to and from a rewritable optical medium such as CD-RW, DVD-RW or DVD-RAM.

To the south bridge 119, a LAN controller 126 is connected via a PCI Express bus. The LAN controller 126 is configured to transfer data to any devices connected to a network.

The embedded controller/keyboard controller IC (EC/KBC) 124 is a one-chip microcomputer comprising an embedded controller and a keyboard controller, which are integrated altogether. The embedded controller controls the power. The keyboard controller controls the keyboard (KB) 13 and the touch pad 16. The embedded controller/keyboard controller IC (EC/KBC) 124 operates in unison with a power-supply controller 125, turning on or off the computer 10 as the user operates the power button 14.

The power-supply controller 125 may receive DC power through the AC adapter 40. In this case, the AC adapter 40 generates system power from the AC power. The system power, thus generated, is supplied to the components of the computer 10. AC power may be supplied from the AC/DC power supply provided in the docking station 200. In this case, system power is generated from this AC power and supplied to the components of the computer 10.

As long as direct current power is supplied from both the AC adapter 40 and the AC/DC power supply 202, the system power that should be supplied to the components of the computer 10 is generated from the direct current power supplied from both the AC adapter 40 and the AC/DC power supply 202. If direct current power is not supplied from through the AC adapter 40, a battery 126 is used to supply power to the components of the computer 10.

Note that the AC/DC adapter 40 and the AC/DC power supply 202 of the docking station 200 have a rated output of 75 W.

The battery can be recharged in two modes, i.e., normal recharging mode and quick recharging mode. In quick recharging mode, the current supplied to the battery is increased three times the current supplied to the battery in normal recharging mode. The battery is therefore recharged faster than in normal recharging mode. The maximum power the computer 10 requires is 70 W while the battery is being recharged in normal mode, and is 150 W while the battery is being recharged in quick mode.

As pointed out already, the AC/DC adapter 40 and the AC/DC power supply 202 of the docking station 200 have a rated output of 75 W. Hence, the battery cannot be recharged in quick mode unless the computer 10 receives power from the AC adapter 40 and the docking station 200.

If the above-mentioned boost function is not performed, the maximum power the computer 10 consumes is about 70 W. If the CPU 111 uses the boost function, the maximum power the computer 10 consumes is about 85 W. If the GPU 105 uses the boost function, the maximum power the computer 10 consumes is about 85 W, too. If both the CPU 111 and the GPU 105 use the boost function, the maximum power the computer 10 consumes is about 100 W.

Therefore, like quick recharging of the battery, the boost function cannot be performed unless the computer 10 receives power from both the AC adapter 40 and the docking station 200.

This is why the computer 10 has a function of first detecting an external device that supplies power to the computer 10 and then enabling or disabling quick recharging mode and the boost function in accordance with the type of device detected. Further, the computer 10 is so designed that both the quick recharging mode and the boost function may not be enabled at the same time.

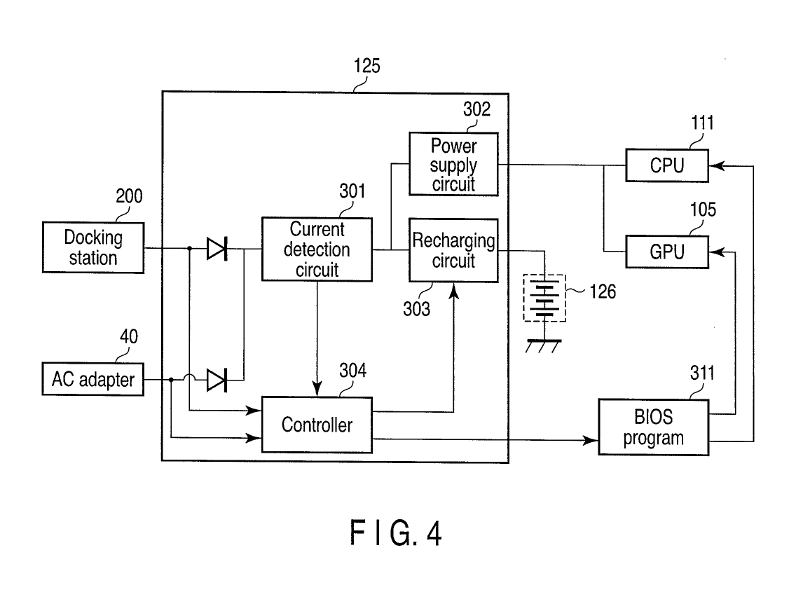

A system designed to enable or disable quick recharging mode or the boost function will be described with reference to FIG. 4.

As shown in FIG. 4, this system comprises a current detection circuit 301, a power supply circuit 302, a recharging circuit 303, and a controller 304. The current detection circuit 301 detects the overall power consumption of the computer 10. The current detection circuit 301 also detects the current (i.e., recharging current) supplied to the battery 126 to recharge the battery 126. The power supply circuit 302 receives power from the power supplied from the AC adapter 40 and/or the docking station 200, and generates system power that should be supplied to the components of the computer 10. The recharging circuit 303 is a circuit that recharges the battery in either normal recharging mode or quick recharging mode if energy remains in the battery in a small amount.

The controller 304 determines whether the AC adapter 40 and/or the docking station 200 supplies power to the computer 10. The controller 304 also monitors the current that the current detection circuit 301 detects. While the recharging circuit 303 is recharging the battery, the controller 304 controls the recharging circuit 303 in accordance with the current. Further, the controller 304 notifies the BIOS program 311 of the power-supply specification for the power supplying device (i.e., maximum current at which the computer 10 operates at maximum power). The controller 304 has a function of supplying the power supply information about any devices that receive power.

The BIOS program 311 determines, from the power supply information, whether the boost function of the CPU 111 and GPU 105 should be enabled or not.

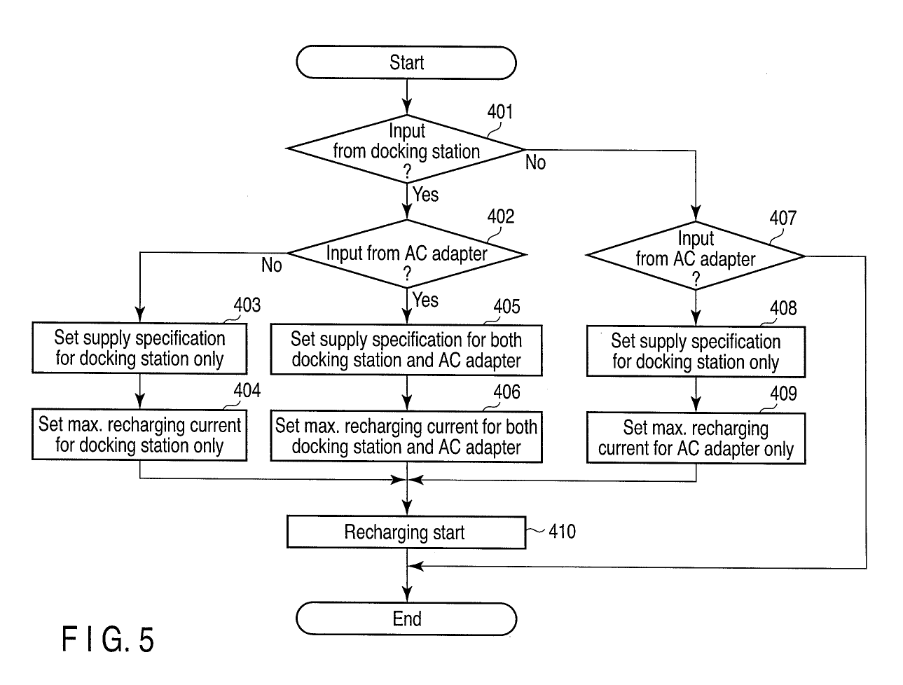

With reference to the flowchart of FIG. 5, the control sequence the controller 304 performs when power is supplied from the docking station 200 or the AC adapter 40 will be described, on the assumption that the AC adapter 40 and the AC/DC power supply 202 have different rated currents.

First, the controller 304 determines whether power is supplied from the docking station 200 (Step 401). If power is supplied from the docking station 200 (Yes in Step 401), the controller 304 determines whether power is supplied from the AC adapter 40, as well (Step 402). If power is not supplied from the AC adapter 40 (No in Step 402), the controller 304 sets such a power-supply specification that only the docking station 200 may supply power to the computer 10 (i.e., maximum supply current, or the largest current that the computer 10 may consume) (Step 403). Further, the controller 304 sets the maximum recharging current at which power is supplied from only the docking station 200 to the battery (Step 404). Then, the controller 304 starts recharging the battery in accordance with the maximum supply current and the maximum recharging current (Step 410). At this point, quick recharging mode is disabled and is not performed at all.

In Step 402 it may be determined that power is supplied from the AC adapter 40 to the computer 10 (Yes in Step 402). If this is the case, the controller 304 sets the power-supply specification for both the docking station 200 and the AC adaptor 40 (i.e., maximum supply current at which the computer 10 operates at maximum power) (Step 405). The controller 304 then sets the maximum current for the recharging current supplied to the battery from both the docking station 200 and the AC adapter 40 (Step 406). Further, the controller 304 begins to recharge the battery in accordance with the maximum supply current and the maximum recharging current (Step 410). Thus, quick recharging is performed.

If current is found not supplied from the docking station 200 in Step 401 (No in Step 401), the controller 304 determines whether power is supplied from the AC adapter 40 (Step 407). If power is supplied from the AC adapter 40 (Yes in Step 407), the controller 304 sets the power-supply specification for supplying from only the AC adaptor 40 to the computer 10 (i.e., maximum supply current) (Step 408). Then, the controller 304 sets the maximum magnitude for the recharging current supplied from only the AC adapter 40, in accordance with the program stored in the BIOS-ROM 121 (Step 409). Next, the controller 304 starts recharging the battery in accordance with the power-supply specification and the maximum recharging current set in Steps 408 and 409, respectively. At this point, quick recharging is disabled and is not performed at all.

Thus, the recharging of the battery 126 can be started, in accordance with which device or devices are supplying power.

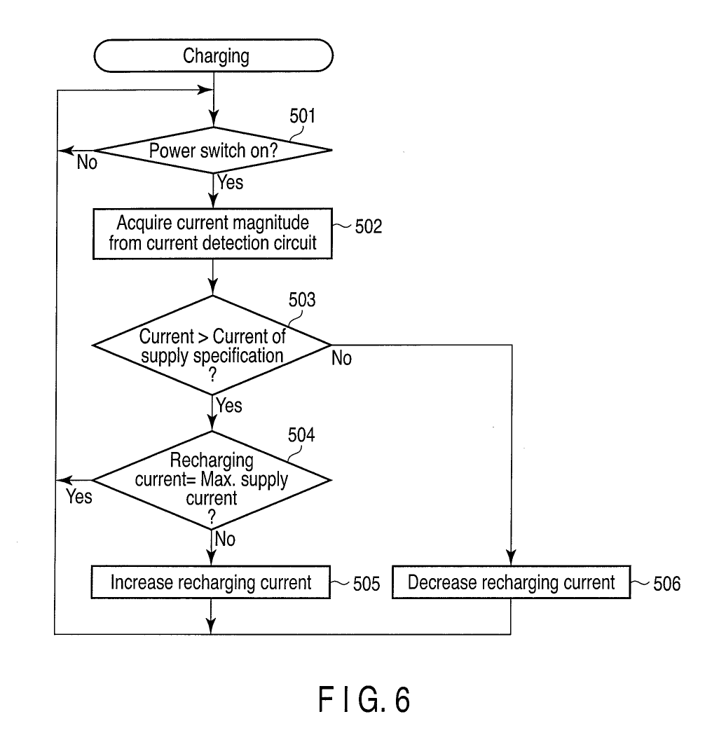

A sequence of controlling the current supplied to the battery 126, thus recharging the battery 126, will be explained with reference to the flowchart of FIG. 6. The control described below is based on the assumption that the system of FIG. 4 has already been activated. Note that the current is controlled in one way if the system has been activated, and in another way if the system has not been activated yet.

A plurality of magnitudes are set for the recharging current that should be supplied to the battery 126. In order to control the recharging current, the controller 304 instructs the recharging circuit 303 to increase the recharging current by one step. If increased in this manner, the recharging current will finally become equal to the maximum recharging current.

The controller 304 determines whether the system has been activated, or whether the power switch is ON (Step 501). If the system has been activated, or if the power switch is ON (Yes in Step 501), the controller 304 acquires, from the current detection circuit 301, the current of the power supplied from the docking station 200 and/or the AC adapter 40 (Step 502). The controller 304 then determines whether the current thus acquired is larger than the current of the power-supply specification (i.e., maximum supply current) (Step 503). If the maximum supply current is found not to be larger than current thus acquired (No in Step 503), the controller 304 instructs the recharging circuit 303 to decrease the recharging current, by one step (Step 506).

In Step 503, the maximum supply current may be found larger than current acquired (Yes in Step 503). In this case, the controller 304 determines whether the current of the power-supply specification (i.e., maximum supply current) is equal to the recharging current (Step 504). If the current of the power-supply specification (i.e., maximum supply current) is equal to the recharging current (Yes in Step 504), Steps 501 to 503 will be repeated, one after another. If the current of the power-supply specification (i.e., maximum supply current) is not equal to the recharging current (No in Step 504), the controller 304 instructs the recharging circuit 303 to increase the recharging current, by one step (Step 505).

The current is so controlled as described above, at the time of recharging the battery.

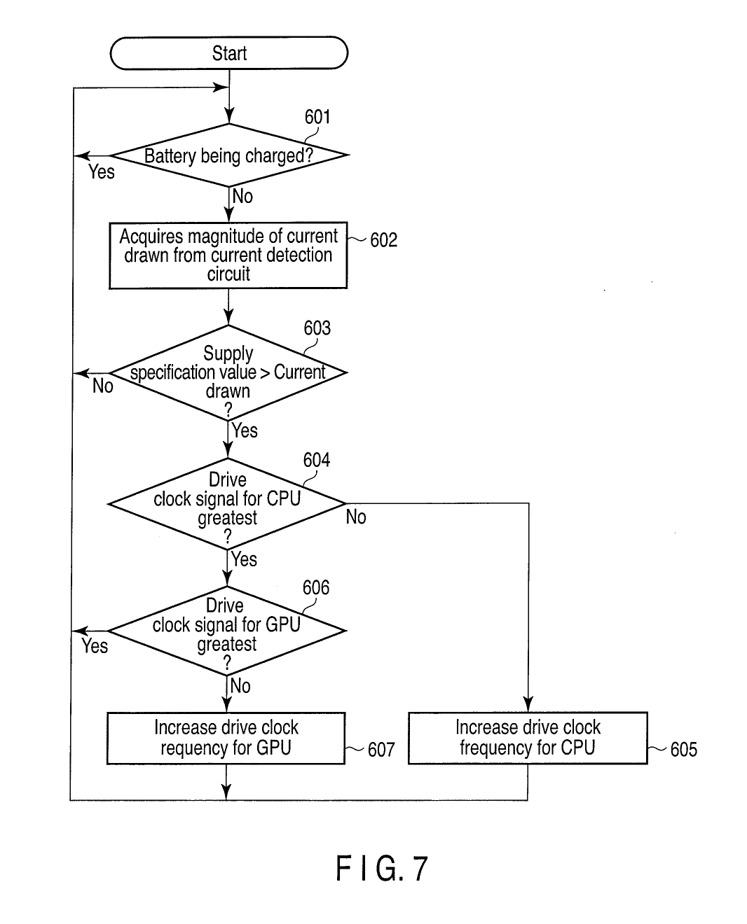

How the boost function of the CPU 111 and GPU 105 is controlled will be explained with reference to the flowchart of FIG. 7. Note that the CPU 111 and GPU 105 cannot perform the boost function while the battery 126 is being recharged. The boost function of the CPU 111 and GPU 105 cannot be used unless both the AC adapter 40 and the docking station 200 supply power to the computer 10. As described above, the controller 304 has the function of notifying the BIOS program 311 of the power-supply specification, and also the function of notifying whether the battery 126 is being recharged or not. The control of the boost function, described below, is based on the assumption that power is supplied from both the AC adapter 40 and the docking station 200 and that the boost function of the CPU 111 and GPU 105 is enabled.

First, the BIOS program 311 acquires recharge information from the controller 304, and determines from this information whether the battery is being recharged (Step 601). If the BIOS program 311 determines that the battery is not being recharged (No in Step 601), it acquires the magnitude of current drawn, detected by the current detection circuit 301 (Step 602).

The BIOS program 311 determines whether the current of the power-supply specification (i.e., maximum supply current) is larger than the of current consumed (Step 603). If the maximum supply current is larger than the current consumed (Yes in Step 603), the BIOS program 311 determines whether the drive clock signal for the CPU 111 is the largest drive clock signal (Step 604). If the drive clock signal for the CPU 111 is not the largest drive clock signal (No in Step 604), the BIOS program 311 increases the drive clock frequency for the CPU 111 (Step 605). If the drive clock signal is the maximum drive clock signal (Yes in Step 604), the BIOS program 311 determines whether the drive clock for the GPU 105 is the largest drive clock signal (Step 606). If the drive clock signal for the GPU 105 is not the largest drive clock signal (No in Step 606), the BIOS program 311 increases the drive clock frequency for the GPU 105 (Step 607).

The boost function of the CPU 111 and GPU 105 is so controlled as described above. If the current of the power-supply specification (i.e., maximum supply current) is not larger than the current consumed, the frequency of the drive clock signal for the CPU 111 and GPU 105 will be decreased.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a controller configured to set the apparatus to a first mode when a first external direct current power is supplied to the apparatus, and to set the apparatus to a second mode when the first external direct current power and a second external direct current power are supplied to the apparatus,
wherein operation of the apparatus at a power greater than the first external direct current power is unavailable when in the first mode, and operation of the apparatus at a power greater than the first external direct current power is available when in the second mode.

2. The apparatus of claim 1, wherein the apparatus is further configured to consume less power when in the second mode than the sum of the first external direct current power and the second external direct current power.

3. The apparatus of claim 1, further comprising a charger configured to charge a battery in a normal charge mode and a quick charge mode,
wherein the quick charge mode is disabled in the first mode and is enabled in the second mode.

4. The apparatus of claim 1, further comprising a processor configured to operate via a first clock signal and a second clock signal, the second clock signal having a higher frequency than the first clock signal,
wherein processor operation via the second clock signal is unavailable when in the first mode and is available when in the second mode.

5. The apparatus of claim 1, further comprising a graphics processor configured to operate via a first clock signal and a second clock signal, the second clock signal having a higher frequency than the first clock signal,
wherein processor operation via the second clock signal is unavailable when in the first mode and is available when in the second mode.

6. A method of controlling an information processing apparatus, the method comprising:
setting the apparatus to a first mode when a first external direct current power is supplied to the apparatus, wherein operation of the apparatus at a power greater than the first external direct current power is unavailable when in the first mode; and
setting the information processing apparatus to a second mode when the first external direct current power and a second external direct current power are supplied to the apparatus, wherein operation of the apparatus at a power greater than the first external direct current power is available when in the second mode.

7. The method of claim 6, wherein the apparatus comprises a charger configured to charge a battery using a normal charge mode and a quick charge mode, wherein the quick charge mode is disabled in the first mode and is enabled in the second mode.

8. The method of claim 6, wherein:
the apparatus comprises a processor configured to operate via a first clock signal and a second clock signal, the second clock signal having a higher frequency than the first operation clock signal, and
processor operation via the second clock signal is unavailable when in the first mode and is available when in the second mode.

9. The method of claim 6, wherein:
the apparatus comprises a graphics processor configured to operate via a first clock signal and a second clock signal, the second clock signal having a higher frequency than the first operation clock signal, and
processor operation via the second clock signal is unavailable when in the first mode by and is available when in the second mode.
